(19) United States
(12) Patent Application Publication
(10) Pub. No.: US 2013/0210516 A1
(43) Pub. Date: Aug. 15, 2013

(54) System and Method for Tracking Online Gambling with GPS to Comply with Legal Jurisdiction

(71) Applicant: Kevin A. Diehl, Mason City, IA (US)

(72) Inventor: Kevin A. Diehl, Mason City, IA (US)

(21) Appl. No.: 13/396,037

(22) Filed: Feb. 14, 2012

(51) Int. Cl. G06F 19/00

(52) U.S. Cl. 463/25

(57) ABSTRACT

The present invention involves the system and method by which individuals and entities can provide online gambling and wagering to citizens of legal age in states that have passed legislation to make such activities legal.

### RELATED APPLICATIONS

| | | |
|---|---|---|
| 8,095,377 | January 2012 | Resato, et al. |
| 8,088,010 | January 2012 | Hill |
| 7,945,502 | May 2011 | Mashinsky, et al. |
| 7,896,743 | March 2011 | Parisien |
| 7,778,913 | August 2010 | Greene, et al. |
| 7,765,115 | July 2010 | Davies, et al. |
| 7,736,221 | June 2010 | Black, et al. |
| 7,698,208 | April 2010 | Hirani, et al. |
| 7,682,251 | March 2010 | Bortnik, et al. |
| 7,636,854 | December 2009 | Muller, et al. |
| 7,614,955 | November 2009 | Farnham, et al. |
| 7,584,154 | September 2009 | Chen, et al. |
| 7,577,847 | August 2009 | Nguyen, et al. |
| 7,370,194 | May 2008 | Morais, et al. |
| 6,665,715 | December 2003 | Houri |
| 6,663,105 | December 2003 | Sullivan, et al. |
| 20110105212 | May 2011 | Fiechter |
| 20110183749 | July 2011 | Allen, et al. |
| 20110201414 | August 2011 | Barclay, et al. |
| 20110212767 | September 2011 | Barclay, et al. |

### FIELD

The present invention relates to the field of legal online gambling and wagering. More specifically, the present invention relates to state-authorized, legal online gambling and wagering following the Department of Justice's recent reinterpretation of the 1961 Wire Act.

### BACKGROUND

For many years in the United States, gambling has been confined to non-online environments, such as in casinos located in Nevada or New Jersey. However, with the Department of Justice's recent reinterpretation of the 1961 Wire Act, there is no longer any federal law that would deny states from authorizing legal online gambling and wagering. The Illegal Gambling Business Act and the Unlawful Internet Gambling Enforcement Act are only effective if the state has not authorized such online gambling and wagering activity. Thus, states have now started the process of passing legislation to make online gambling and wagering legal. California, New Jersey, New York, Illinois, Nevada, and Iowa have already passed or are on the verge of passing legislation making online gambling and wagering legal. More states are certain to follow. However, not every state could ultimately decide to permit this particular form of gambling and wagering.

### SUMMARY

The present invention involves the system and method by which individuals and entities can provide online gambling and wagering to citizens of legal age in states that have passed legislation to make such activities legal.

### DRAWINGS' DESCRIPTION

FIG. 1 shows the registration process at 100, the service provider's receipt of electronic information at 200, the service provider's installation of the application to the customer's mobile devices through the customer's download at 300, the menu choices of game and type (single- or multi-player) to the customer after logging in at 400, the customer's selection of the game at 500, the customer's bet at 600, the customer's playing of the game and the service provider's monitoring of the location where the customer is playing the game at 700, the customer's pay out from the game if successful, and the customer logging out.

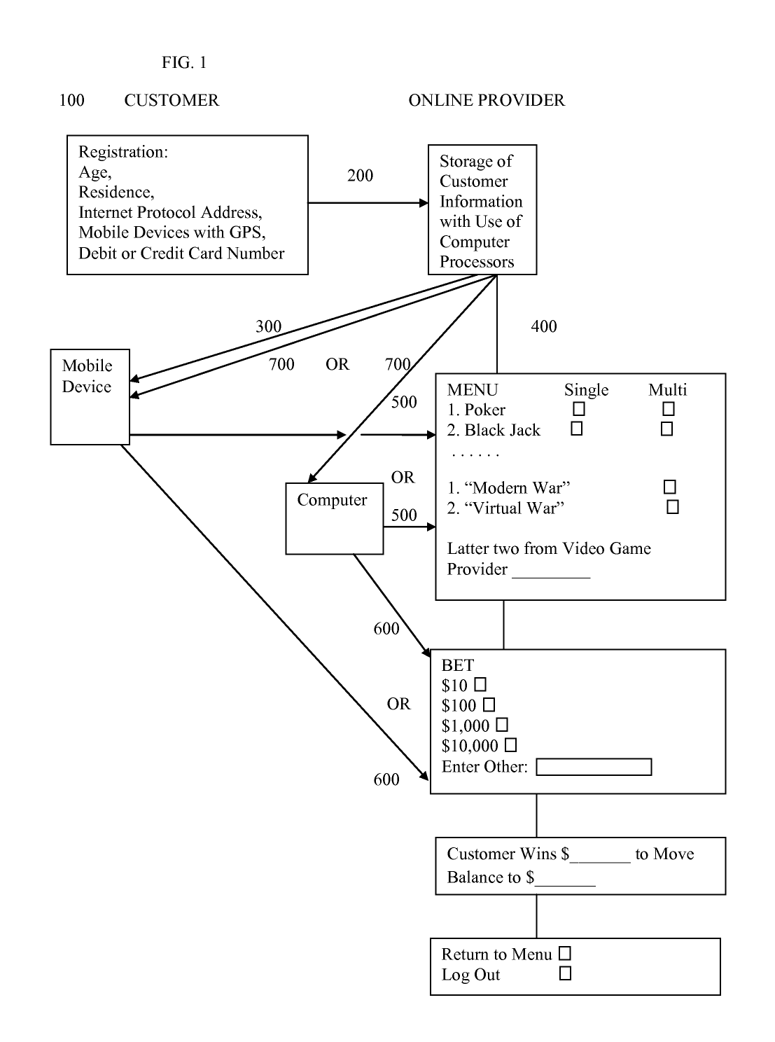

### DETAILED

As required, detailed embodiments of the present invention are disclosed herein. However, it is to be understood that the disclosed embodiments are merely illustrative of the invention that can be embodied in various forms. Thus, specific structural and functional details disclosed herein are not to be interpreted as limiting but merely as the basis for the claims and as the representative basis for educating those individuals skilled in the art variously to employ the present invention.

The present invention involves converting any version of any gambling or wagering activity that is undertaken in any casino or similar establishment worldwide now or at any time in the future into an online experience to the extent doing so is legal within the state. This online experience includes the use of any type of computer, mobile communications device, or in general any portable digital device to access these gambling or wagering activities online so as to make them portable experiences for the player if so desired. As part of this experience then, customers can not only play these gambling or wagering games but also wager on these games (commit their own money to bets on the outcomes of these gambling games). The customers wager their money at the same points at which they would do so in the physical gambling or wagering environment represented in any casino.

Before engaging in any of these activities, the customer must first register at 100 with their age, address, debit/credit card information, any mobile devices that they would utilize with global positioning systems (GPS) capability, etc. for the provider to determine whether they are of legal age to gamble in that particular state and whether it is legal to online gamble in that particular state. Ideally, copies of the birth certificate and the driver's license of the potential customer would be electronically provided at 200 to the service provider to store as proof of age and residence. The provider would also request the customer's permission to load an application on the GPS device at 300 for them to track where the customer is utilizing the particular device. Then, with the debit/credit card information already registered, the customer would only have to indicate through data entry or clicking on number choices the currency value of the bet they are seeking to make.

Initially, the customer's internet protocol address would be verified as within the confines of states where online gambling and wagering is legal. The system would continue to verify that fact at every log in.

To monitor whether the particular customer is located within the confines of the state that has made such online gambling and wagering activities legal, their portable electronic device must have GPS tracking capability at 700. What the provider of the service would do is provide an application for that mobile device to monitor whether the customer is within states that legally permit such activities. As the customer would move closer toward the border with any state where such activities are not legal, the mobile device with this application would warn the customer of this fact and also of the fact that the application would disconnect them from the activity on reaching the border with the other state. The said application would do just as described. Such application would be necessary for compliance with the 1961 Wire Act, Illegal Gambling Business Act, the Unlawful Internet Gambling Enforcement Act, and the regulatory environment in general.

This gambling and wagering set of systems and methods could also include gambling and wagering on computer games. For instance, the owner of this patent for online gambling and wagering could choose to partner with any computer game manufacturer, such as Electronic Arts, and provide the gambling and wagering part to any of their games that would be permitted to be involved in gambling and wagering activity under the laws and regulations of the US. Thus, any combat game in particular could permit any of age customer to wager whatever currency number they desired on success to certain levels in any of those games (so long as the state where located has made such activities legal).

This gambling and wagering set of systems and methods could be at the single-player or multi-player level for the casino games and other providers' games. Thus, the single-player would bet on success competing with the computer itself while the multi-players would bet on which of them would outmatch the others.

What is claimed is:

1. The system and method of utilizing computer processors to monitor activities, store data, transact currency bets with, and otherwise provide online gambling and wagering activity services to any customer where that customer can make use of any computer or any portable device to access the internet (or other similar connectivity) to engage in casino-style or other games as chosen from the service provider's menu and place bets or wagers on any such game so long as the customer's location can be continuously monitored through internet protocol addresses or GPS signals to the extent that the customer can be logged out on reaching states where such activity is not legal.

2. The method of claim 1, wherein the customer is involved in any single-player or multi-player game with the single-player game involving bets on competitions versus the computer game itself and the multi-player game involving bets on competitors versus each other.

3. The method of claim 1, wherein the customer's actions are tracked through internet protocol registrations for computers and through GPS monitoring for portable devices to ensure that the customer is engaged in the gambling activity within the borders of states where such activity is legal and where, for the latter of the two, the customer would be warned of nearing states where such activity is not legal and would have their connections to the service disconnected on reaching the border of the states where such activity is not legal.

4. The method of claim 1, wherein the customer can engage in any casino-style game or game from other content providers, such as combat games from Electronic Arts.

5. The method of claim 1, wherein the bets are placed at times in the online game where they would be placed during any such actual game in any casino or, if so desired for other types of games as well, at the beginning of each such game.

6. The method of claim 1, wherein, before beginning to utilize the service, the customer registers debit or credit card information on creating the log in to the service so that the customer must only disclose the currency figure bet during each part of the game and not have to register this information continually.

7. The method of claim 1, wherein the customer also registers their age, residence, and other identifying information through the electronic provision of supporting documents.
